(19) United States
(12) Patent Application Publication
(10) Pub. No.: US 2016/0208554 A1
(43) Pub. Date: Jul. 21, 2016

(54) UPLOCK LADDER ANCHORING SAFETY ATTACHMENT

(71) Applicant: Ronald Lee Harris, Gig Harbor, WA (US)

(72) Inventor: Ronald Lee Harris, Gig Harbor, WA (US)

(21) Appl. No.: 14/969,394

(22) Filed: Dec. 15, 2015

Related U.S. Application Data
(60) Provisional application No. 62/103,957, filed on Jan. 15, 2015.

(51) Int. Cl. E06C 1/34

(52) U.S. Cl. CPC E06C 1/34

(57) ABSTRACT

The ladder anchoring attachment of the preferred embodiments comprises a mounting coupler designed to attach the ladder anchoring safety attachment to a ladder, a swivel coupling attached to the mounting coupler, a telescoping arm attached to the opposite end of the swivel coupling from the mounting coupler, and a clamp attached to the distal end of the telescoping arm, where the clamp is designed to be capable of clamping to a solid object capable of anchoring the ladder while the ladder is in use. The ladder anchoring attachment of the preferred embodiments is designed to provide a way to secure a ladder against one or more of a) solid objects and b) structures to hold the ladder steady while in use, where the one or more of a) solid objects and b) structures may have preferred anchoring points that can vary significantly in their distance and position from the ladder.

### CROSS-REFERENCE TO RELATED APPLICATIONS

This application is a non-provisional continuation of U.S. Provisional Patent Application Ser. No. 62/103,957 filed 15 Jan. 2015 and entitled “LADDER SAFETY MECHANISM”, the priority of which is claimed by this application, and the entire contents and substance of which are hereby incorporated in total by reference.

### BRIEF DESCRIPTION OF THE FIGURES

FIG. 1 is a schematic representation of the system of the preferred embodiments.

FIG. 2 is a schematic representation of the system of the preferred embodiments, where a second swivel coupling is attached to the distal end of the arm.

FIG. 3 is a schematic representation of the system of the preferred embodiments, where the arm is allowed to traverse a range of angles at least one plane.

FIG. 4 is a schematic representation of the system of the preferred embodiments, where the second coupler allows the clamp to traverse arrange of angles in at least one plane.

FIG. 5 is a schematic representation of the system of the preferred embodiments, where the swivel couplings allow the clamp to be adjusted through a range of angles in at least two planes.

FIG. 6 is a schematic representation of the system of the preferred embodiments, where at least one pin allows at least one swivel coupling to be locked in at least one fixed position.

FIG. 7 is a schematic representation of the system of the preferred embodiments, where the clamp is a bar-type clamp.

FIG. 8 is a schematic representation of the system of the preferred embodiments, where the clamp is a quick-release bar-type clamp.

FIG. 9 is a schematic representation of the system of the preferred embodiments, where the clamp is a quick release bar type clamp, and where the swivel couplings allow adjustment of the clamp in at least two planes, where pins can be used to fix at least one coupler in at least one fixed position, where a threaded fitting allows the telescoping arm to be locked into position at a fixed length.

FIG. 10a is a schematic representation of the system of the preferred embodiments, where the ladder has been anchored to one variation of a solid object using the system of the preferred embodiments.

FIG. 10b is a schematic representation of the system of the preferred embodiments, where the ladder has been anchored to another variation of a solid object using the system of the preferred embodiments, with varied positioning relative to the latter.

FIG. 11 is a schematic representation of the system of the preferred embodiments, where a rigid member has been passed through the hollow rung of the ladder and two of the ladder anchoring attachments of the first preferred embodiment have been attached to either end of the rigid member.

### DESCRIPTION OF THE PREFERRED EMBODIMENTS

The following description of the preferred embodiments of the invention is intended to enable someone skilled in the prior art to make and use this invention, but is not intended to limit the invention to these preferred embodiments.

### 1. First Preferred Embodiment

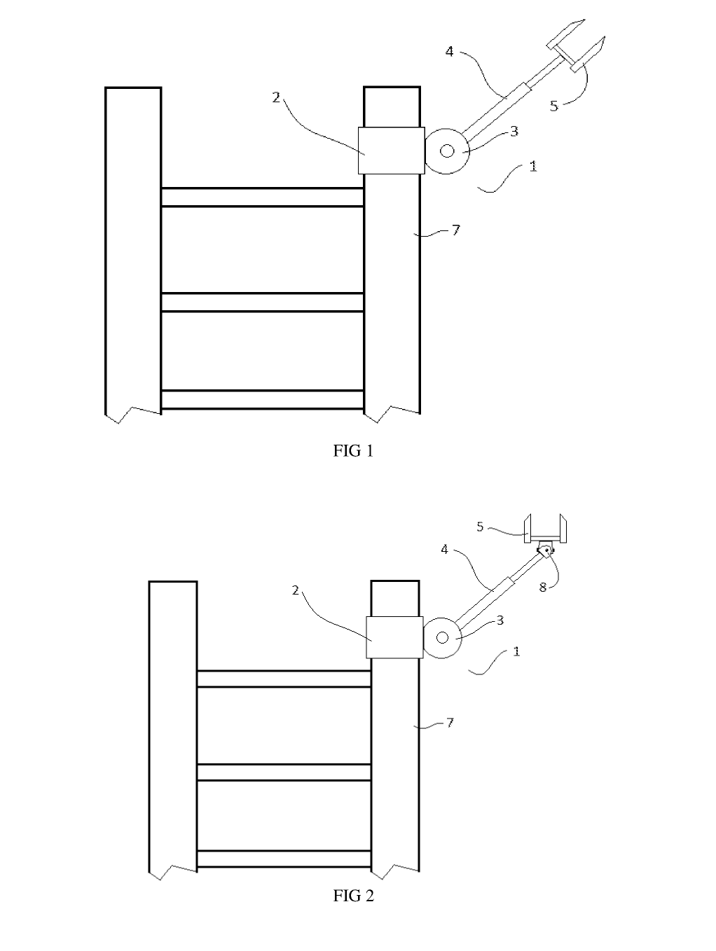

As shown in FIG. 1, the ladder anchoring attachment 1 of the preferred embodiments comprises a mounting coupler 2 designed to attach the ladder anchoring safety attachment to a ladder 7, a swivel coupling 3 attached to the mounting coupler, a telescoping arm 4 attached to the opposite end of the swivel coupling 3 from the mounting coupler, and a clamp 5 attached to the distal end of the telescoping arm 4, where the clamp 5 is designed to be capable of clamping to a solid object 6 capable of anchoring the ladder 7 while the ladder 7 is in use. The ladder anchoring attachment 1 of the preferred embodiments is designed to provide a way to secure a ladder 7 against one or more of a) solid objects 6 and b) structures to hold the ladder 7 steady while in use, where the one or more of a) solid objects 6 and b) structures may have preferred anchoring points that can vary significantly in their distance and position from the ladder 7.

As shown in FIG. 1, the system of the first preferred embodiments has a mounting coupler 2 that attaches the ladder anchoring attachment 1 to a ladder 7. Preferably the mounting coupler 2 attaches the ladder anchoring attachment 1 removably to the ladder 7. In one preferred variation, the mounting coupler 2 slides over one of the vertical beams of the ladder 7. In this preferred variation, a clamping action removably secures the mounting coupler 2 to the ladder 7 beam. There are many prior art mechanisms which can be used to accomplish this mounting, including but not limited to a) C-clamp 5 type systems in which a lead screw presses a friction pad against the ladder 7 beam, b) Hinged systems in which a lead screw type system biases two hinged halves of a clamping system closer together so that they press against the ladder 7 beam, and c) any other suitable removable removing coupler. However, any suitable removable mounting mechanism may be used to attach the mounting coupler 2 to the ladder 7 beam in this preferred variation. In an alternate variation, the mounting coupler 2 could be mounted in at least one of a permanent and a semi-permanent fashion to the ladder 7. There are many ways to accomplish this mounting, including bolts, screws, welding, adhesives, and any other suitable mounting means. In another alternate variation, the mounting coupler 2 can be attached to the rungs of the ladder 7 via any suitable method. The mounting coupler 2 may, however, be mounted to the ladder 7 in any suitable way on any suitable portion of the ladder 7.

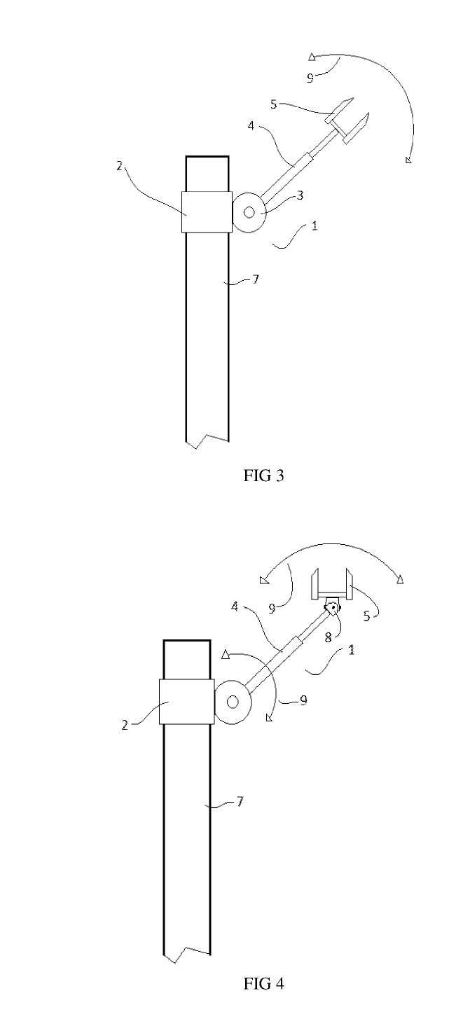

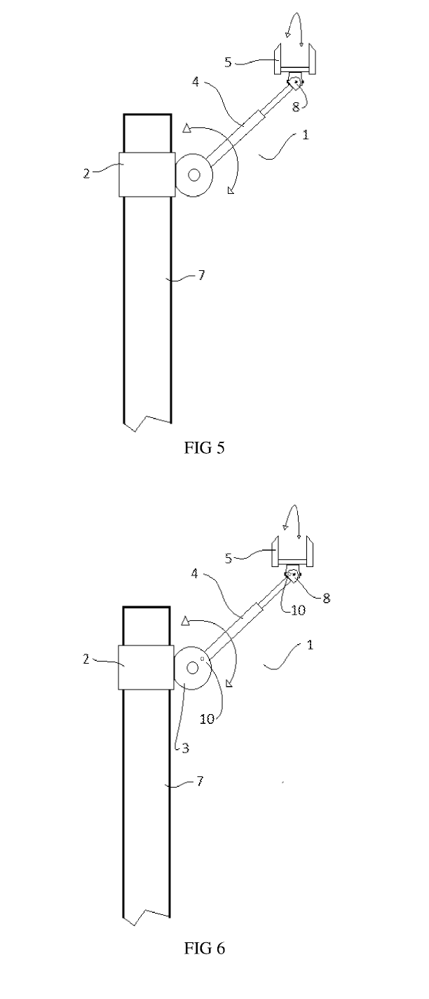

As shown in FIG. 1, the system of the preferred embodiments includes a swivel coupling 3 attached to the mounting coupler. A telescoping arm 4 is attached to the opposite side of the swivel coupling 3. As shown in FIG. 3, preferably the swivel coupling 3 allows the telescoping arm 4 to traverse through a range of angles in at least one plane 9 relative to the mounting coupler. The swivel coupling 3 can be any suitable swivel coupling 3, including but not limited to a knuckle joint, a ball joint, a universal joint, and any other suitable swivel coupling 3. Preferably the swivel coupling 3 can be locked into a fixed angle by the user. As shown in FIG. 6, in one preferred variation, the swivel coupling 3 has a fork and a center piece with an axle through both pieces, where there are radial holes through both the fork and the center piece around the axis of the axle, where a pin 10 can be inserted into the holes in the fork and when the holes are aligned with the holes in the center piece, through the holes in the center piece. This locks the swivel coupling 3 into a given angle. In another preferred variation, the center piece may have a conical shape centered around the axle hole and the fork may have a conical depression matching the conical shape, where a clamping force can be asserted onto the fork to create friction between the conical shape and the conical depression to lock the swivel joint into a fixed position. In another variation, a section of the swivel coupling 3 attached to the mounting coupler 2 can have radial gear teeth extending outward from the axle hole, and a section of the swivel coupling 3 attached to the telescoping arm 4 can have radial gear teeth extending outward from its axle hole, allowing the teeth to engage and lock the swivel coupling 3 in a particular position when a clamping force is applied to the joint. In another variation, a locking ball joint known in prior art is used for the swivel coupling 3. The swivel coupling may be locked into an angular position with at least one of a pin 10, a bolt 10, and a screw 10. This may be accomplished by having the at least one of a pin 10, a bolt 10, and a screw 10 interface with at least one of a hole, a groove, and a depression in the pivoting center piece of the swivel coupler, after having passed through the outside housing of the swivel coupler. In another variation, it may be accomplished by having the at least one of a pin 10, a bolt 10, and a screw 10 create friction on the pivoting center piece of the swivel coupling. The swivel coupling 3 may, however, have any suitable design and construction. The swivel coupling 3 may not be capable of being locked into a given position.

As shown in FIG. 1, there is a clamp 5 mounted to the distal end of the telescoping arm 4 from the mounting coupler. The telescoping arm 4 is designed to be capable of extending and retracting over a range of distances. Preferably the telescoping arm 4 can be fixed at a given length. In one preferred variation, a threaded collar 13 on the joints of the telescoping collar can be tightened or loosened to provide a clamping force between the segments of the telescoping arm 4 and cause friction, locking the telescoping arm 4 into a desired length of extension. The telescoping arm 4 may, however, have any suitable construction. The telescoping arm 4 preferably allows the clamp 5 to be positioned to anchor the ladder 7 to solid objects 6 that can range in distance from the ladder 7 when the ladder 7 is in use. However, the telescoping arm 4 can be used for any suitable reason. The swivel coupling 3 preferably allows the clamp 5 to anchor the ladder 7 to solid objects 6 that range in spatial position relative to the ladder 7 when the ladder 7 is in use. However, the swivel coupling 3 may be used for any suitable purpose.

As shown in FIG. 2, preferably there is a second swivel coupling 8 attached to the distal end of the telescoping arm 4, and the clamp 5 is attached to the opposite side of the swivel coupling 3 from the telescoping arm 4. As shown in FIG. 4, preferably the second swivel joint allows the clamp 5 to traverse a range of angles in at least one plane 9 relative to the telescoping arm 4. The second swivel coupling 8 can have any suitable construction, including those listed for the first swivel coupling 3. In one preferred variation, the second swivel coupling 8 is a universal joint. In another preferred variation, the second swivel coupling 8 is a locking universal joint which can be fixed in a given position. The second swivel joint preferably allows the clamp 5 to fix to objects capable of anchoring the ladder 7, where the objects may have different orientations and the clamp 5 may have to be positioned at at least one of a) various angles and b) various angular orientations of the clamp 5 jaws. In a preferred variation, the second swivel joint is a universal joint. In another variation, the second swivel joint is an off-the-shelf universal joint with a groove machined through one end of the joint, and the slide bar of a bar clamp 11 inserted into the groove and pinned in place. The second swivel may, however, have any suitable design. As shown in FIG. 5, in a preferred embodiment, the second swivel joint allows the clamp 5 to traverse a range of angles in two planes 9 relative to the distal end of the telescoping arm 4. The second swivel joint may, however, have any suitable travel. The second swivel joint may, however, be used for any suitable purpose. The second swivel joint may, however, have any suitable construction.

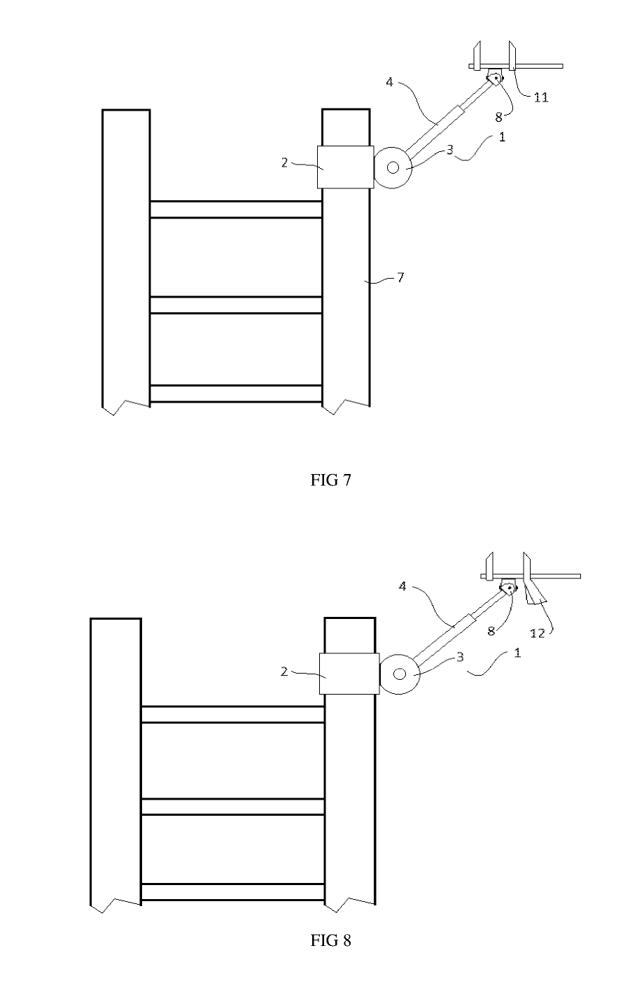

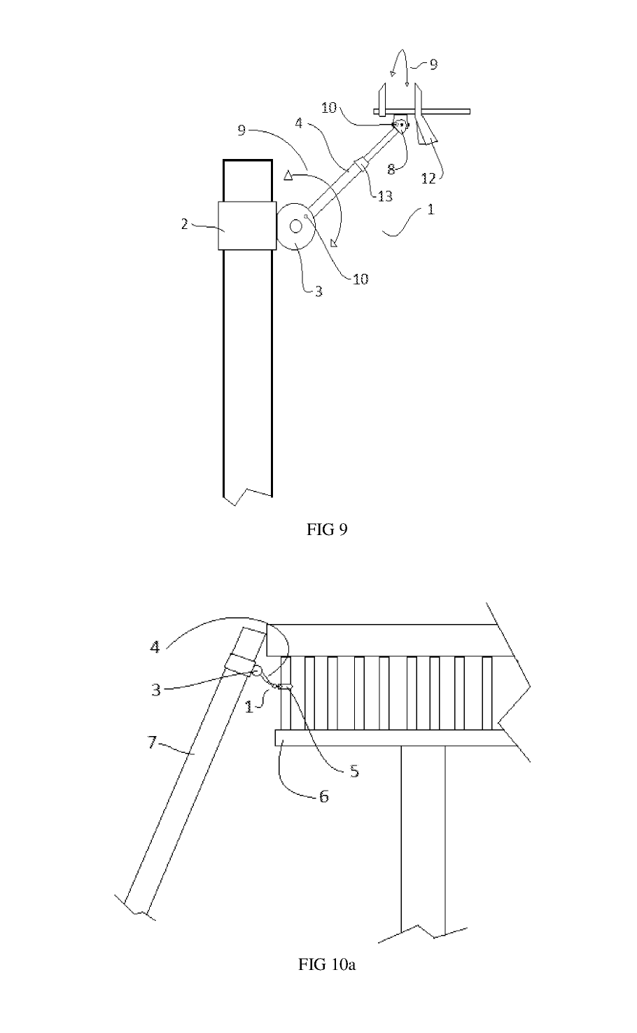

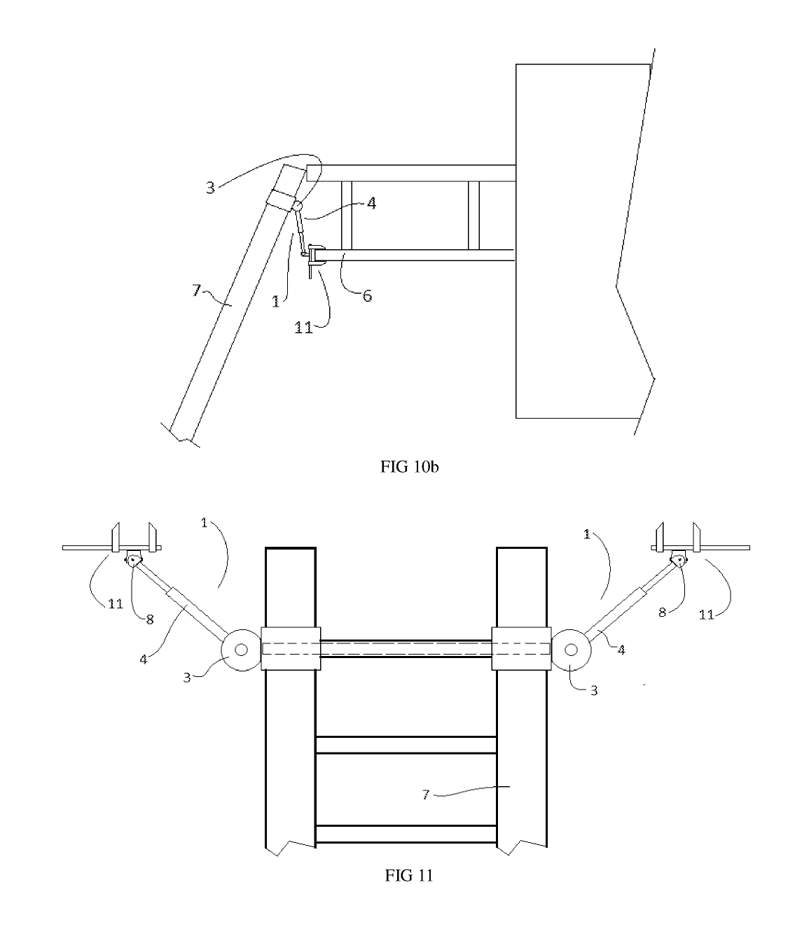

The clamp 5 may have any suitable configuration and design for removably anchoring to one or more of a) a solid object 6 and b) a part of a structure. As shown in FIG. 7, in one preferred variation the clamp 5 has a bar clamp 11 construction. As shown in FIG. 8, in another preferred variation, the clamp 5 has a quick release bar clamp 12 construction. As shown in FIGS. 10a and 10b, the clamp 5 is preferably capable of providing an anchoring force by using friction and clamping force to anchor to one or more of a) solid objects 6 and b) parts of structures, which can include but are not limited to: railings, ledges, pieces of scaffolding, beams, patio floors, shelves, walkways, tree limbs, telephone poles, and any other suitable point for anchoring. As shown in FIGS. 10a and 10b, the anchor point the clamp 5 engages may vary in both distance and spatial position relative to the ladder 7. Prior art systems are not capable of using anchor points that can vary significantly in both position and distance from the ladder 7, limiting the situations in which the ladder 7 can be safely anchored. The clamp 5 may, however, be used in any suitable manner to anchor the ladder 7. The clamp 5 may, however, be used in any suitable manner.

The ladder anchoring attachment 1 can be used in multiples of at least two per ladder 7 to provide appropriate anchoring. In one preferred variation, a ladder anchoring attachment 1 is mounted bilaterally on both beams of a ladder 7. As shown in FIG. 11, in a preferred variation, the ladder anchoring attachment 1 is mounted to either end of a rigid member that is passed through the hollow rungs found on some ladders 7. In this preferred variation, the rigid member may be at least one of a tube and a bar of any suitable shape, with a size small enough to pass through the hollow passage in the ladder 7 rung. In this preferred variation, the ladder anchoring attachment 1 can be attached to the end of the rigid member by any suitable means, including but not limited to threads, a clamp 5 attached to the ladder anchoring attachment 1, threaded fasteners, and any other suitable means of attachment. The ladder anchoring attachment 1 may, however, be used in any suitable manner.

As a person skilled in the art will recognize from the previous detailed description and from the figures and claims, modifications and changes can be made to the preferred embodiments of the invention without departing from the scope of this invention defined in the following claims.

I Claim:

1) An articulated ladder anchoring attachment, wherein a mounting coupler is adapted to attach the device to a ladder, wherein a swivel coupling is attached to the mounting coupler, wherein a telescoping arm is attached to the opposite end of the swivel coupling, wherein a clamp is attached to the distal end of the telescoping arm, wherein the clamp is sufficient to clamp to a solid object capable of anchoring the ladder during use.

2) The articulated ladder anchoring attachment of claim 1, wherein a second swivel coupling is attached to the distal end of the telescoping arm, and the clamp is attached to the opposite end of the second swivel coupling.

3) The articulated ladder anchoring attachment of claim 1, wherein the swivel coupling allows the telescoping arm to traverse a range of angles relative to the mounting coupler in at least one plane.

4) The articulated ladder anchoring attachment of claim 2, wherein the swivel coupling allows the telescoping arm to traverse a range of angles relative to the mounting coupler in at least one plane, and wherein the second swivel coupling allows the clamp to traverse a range of angles relative to the mounting coupler in at least one plane.

5) The articulated ladder anchoring attachment of claim 4, wherein the two swivel couplings allow adjustment of the position of the clamp in at least two planes.

6) The articulated ladder anchoring attachment of claim 3, wherein the swivel coupling can be locked into position at a desired angle in its range of angles.

7) The articulated ladder anchoring attachment of claim 5, wherein at least one of the two swivel couplings can be locked into position at a desired angle in the range of angles they are free to traverse.

8) The articulated ladder anchoring attachment of claim 6, wherein at least one of A) a pin, B) a bolt, and c) a screw is used to lock the swivel coupling into position at the desired angle.

9) The articulated ladder anchoring attachment of claim 7, wherein at least one of A) a pin, B) a bolt, and c) a screw is used to lock at least one of the two swivel couplings into position at the desired angle.

10) The articulated ladder anchoring attachment of claim 2, wherein the clamp is constructed as a bar clamp.

11) The articulated ladder anchoring attachment of claim 2, wherein the clamp is constructed as a quick-release bar clamp.

12) The articulated ladder anchoring attachment of claim 7, wherein the clamp is constructed as a bar clamp.

13) The articulated ladder anchoring attachment of claim 1, wherein the telescoping arm can be locked into place at a given extension length.

14) The articulated ladder anchoring attachment of claim 2, wherein the telescoping arm can be locked into place at a given extension length.

15) The articulated ladder anchoring attachment of claim 7, wherein the telescoping arm can be locked into place at a given extension length.

16) The articulated ladder anchoring attachment of claim 12, wherein the telescoping arm can be locked into place at a given extension length.

17) The articulated ladder anchoring attachment of claim 1, wherein the articulated ladder anchoring attachment permits the ladder to be anchored to solid objects that may vary significantly in at least one of A) spatial position and B) distance from the ladder.

18) The articulated ladder anchoring attachment of claim 2, wherein the articulated ladder anchoring attachment permits the ladder to be anchored to solid objects that may vary significantly in at least one of A) spatial position and B) distance from the ladder.

19) The articulated ladder anchoring attachment of claim 7, wherein the articulated ladder anchoring attachment permits the ladder to be anchored to solid objects that may vary significantly in at least one of A) spatial position and B) distance from the ladder.

20) The articulated ladder anchoring attachment of claim 16, wherein the articulated ladder anchoring attachment permits the ladder to be anchored to solid objects that may vary significantly in at least one of A) spatial position and B) distance from the ladder.
